(19) United States
(12) Patent Application Publication
(10) Pub. No.: US 2025/0096612 A1
(43) Pub. Date: Mar. 20, 2025

(54) POWERED DEVICE, POWER SOURCING EQUIPMENT, AND POWER-OVER-FIBER SYSTEM

(71) Applicant: KYOCERA CORPORATION, Kyoto-shi, Kyoto (JP)

(72) Inventor: Takahiro KOBAYASHI, Sagamihara-shi, Kanagawa (JP)

(21) Appl. No.: 17/754,765

(22) PCT Filed: Sep. 16, 2020
(86) PCT No.: PCT/JP2020/034999

§ 371 Date: Apr. 12, 2022

(30) Foreign Application Priority Data
Oct. 18, 2019 (JP) 2019-190632
Oct. 21, 2019 (JP) 2019-191738

(51) Int. Cl. H02J 50/30; G02B 6/42; G02B 26/04; H04B 10/80

(52) U.S. Cl. CPC H02J 50/30; G02B 6/4246; G02B 26/04; H04B 10/807

(57) ABSTRACT

A powered device includes a photoelectric conversion element configured to convert power source light input from an exterior of the device into electric power; an electric power monitor configured to monitor surplus electric power; a light returner configured to output, as return light, a portion of the power source light to the exterior of the device; and a return controller configured to control the light returner in accordance with a result of monitoring by the electric power monitor. Power sourcing equipment includes a laser oscillator configured to convert electric power into power source light for output to an exterior of the equipment; a light receiving element configured to receive return light returned from the exterior of the equipment; and a power controller configured to control power of the power source light in accordance with the return light.

### RELATED APPLICATIONS

The present application is a National Phase of International Application No. PCT/JP2020/034999 filed Sep. 16, 2020, which claims priority to Japanese Application No. 2019-190632, filed Oct. 18, 2019 and Japanese Application No. 2019-191738, filed Oct. 21, 2019.

### TECHNICAL FIELD

The present disclosure relates to a powered device, power sourcing equipment, and a power-over-fiber system.

### BACKGROUND ART

Recently, optical power sourcing systems that convert electric power into light (referred to as power source light) to transmit and then convert the power source light into electric energy for use as electric power have been studied. Patent Literature 1 describes an optical communication device including: an optical transmitter that transmits signal light modulated from an electric signal and power source light for supplying electric power; an optical fiber that includes a core for transmitting the signal light, a first cladding formed around the core and having a lower refractive index than the core and for transmitting the power source light, and a second cladding formed around the first cladding and having a lower refractive index than the first cladding; and an optical receiver that is operated by the electric power converted from the power source light transmitted through the first cladding of the optical fiber and that converts the signal light transmitted through the core of the optical fiber into the electric signal.

### CITATION LIST

### Patent Literature

PTL 1: Japanese Unexamined Patent Application Publication No. 2010-135989

### SUMMARY OF INVENTION

### Technical Problem

In optical power sourcing systems according to the related art, the magnitude of power source light transmitted from power sourcing equipment to a powered device is preset on the power sourcing side. Thus, in the case that the magnitude of electric power consumed on the powered side varies, adjusting the magnitude of the power source light to this variation is difficult. In this case, the powered device may have surplus electric power.

### Solution to Problem

A powered device according to the present disclosure includes:
a photoelectric conversion element configured to convert power source light input from an exterior of the device into electric power;
an electric power monitor configured to monitor surplus electric power;
a light returner configured to output, as return light, a portion of the power source light to the exterior of the device; and
a return controller configured to control the light returner in accordance with a result of monitoring by the electric power monitor.

Power sourcing equipment according to the present disclosure includes:
a laser oscillator configured to convert electric power into power source light for output to an exterior of the equipment;
a light receiving element configured to receive return light returned from the exterior of the equipment; and
a power controller configured to control power of the power source light in accordance with the return light.

A powered device according to another aspect of the present disclosure includes:
a photoelectric conversion element configured to convert power source light input from an exterior of the device into electric power;
a light returner capable of outputting, as return light, a portion of the power source light to the exterior of the device;
an electric power monitor configured to monitor a relation between supply and demand of electric power at a load; and
a return controller configured to control the light returner,
where the return controller causes the return light to be output from the light returner in accordance with a result of monitoring by the electric power monitor, the return light representing a value of a binary or multivalued signal.

Power sourcing equipment according to another aspect of the present disclosure includes:
a laser oscillator configured to convert electric power into power source light for output to an exterior of the equipment;
a light receiving element configured to receive return light returned from the exterior of the equipment; and
a power controller configured to switch power of the power source light stepwise in accordance with the return light.

A power-over-fiber system according to the present disclosure includes:
the above-described powered device; the above-described power sourcing equipment;
an optical fiber for transmitting the power source light; and
an optical fiber for transmitting the return light.

### BRIEF DESCRIPTION OF DRAWINGS

FIG. 1 is a configuration diagram of a power-over-fiber system according to a first embodiment of the present disclosure.

FIG. 2 is a configuration diagram of a power-over-fiber system according to a second embodiment of the present disclosure.

FIG. 3 is a configuration diagram of the power-over-fiber system according to the second embodiment of the disclosure and illustrates, for example, optical connectors.

FIG. 4 is a configuration diagram of a power-over-fiber system according to an alternative embodiment of the present disclosure.

FIG. 5 is a configuration diagram illustrating a power-over-fiber system according to a third embodiment employing a unit for returning a portion of power source light.

FIG. 6 is a timing chart illustrating an example of operation of the power-over-fiber system according to the third embodiment.

FIG. 7 is a configuration diagram illustrating a power-over-fiber system according to a fourth embodiment employing a unit for returning a portion of power source light.

FIG. 8 is a timing chart illustrating an example of operation of the power-over-fiber system according to the fourth embodiment.

### DESCRIPTION OF EMBODIMENTS

An embodiment of the present disclosure will be described below with reference to the drawings.

### (1) Overview of System

### First Embodiment

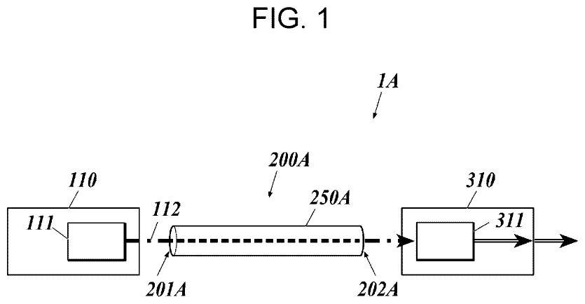

As illustrated in FIG. 1, a power-over-fiber (PoF) system 1A according to the present embodiment includes power sourcing equipment (PSE) 110, an optical fiber cable 200A, and a powered device (PD) 310.

It should be noted that the power sourcing equipment in the present disclosure is a device converting electric power into optical energy for supply and that the powered device is a device supplied with optical energy and converting the optical energy into electric power.

The power sourcing equipment 110 includes a power sourcing semiconductor laser 111.

The optical fiber cable 200A includes an optical fiber 250A forming a transmission path for power source light.

The powered device 310 includes a photoelectric conversion element 311.

The power sourcing equipment 110 is connected to an electric power source to electrically drive, for example, the power sourcing semiconductor laser 111.

The power sourcing semiconductor laser 111 is brought into laser oscillation by electric power from the electric power source and outputs power source light 112.

One end 201A of the optical fiber cable 200A can be connected to the power sourcing equipment 110 and another end 202A of the optical fiber cable 200A can be connected to the powered device 310, and the optical fiber cable 200A transmits the power source light 112.

The power source light 112 from the power sourcing equipment 110 is input to the one end 201A of the optical fiber cable 200A. The power source light 112 propagates in the optical fiber 250A and is output from the other end 202A to the powered device 310.

The photoelectric conversion element 311 converts the power source light 112, which has been transmitted through the optical fiber cable 200A, into electric power. The electric power, which has been converted by the photoelectric conversion element 311, serves as driving electric power required within the powered device 310. Furthermore, the powered device 310 can output the electric power, which has been converted by the photoelectric conversion element 311, to an external device.

A semiconductor material constituting a semiconductor region for achieving an optic/electric conversion effect between the power sourcing semiconductor laser 111 and the photoelectric conversion element 311 is of a semiconductor having a short laser wavelength of 500 nm or less.

Since the semiconductor with a short laser wavelength has a large band gap and high photoelectric conversion efficiency, the photoelectric conversion efficiencies on the optical power sourcing side and the powered side are enhanced and the optical power sourcing efficiency is enhanced.

As such a semiconductor material, a semiconductor material of a laser medium, such as diamond, gallium oxide, aluminum nitride, or GaN, having a laser wavelength (fundamental) of 200 to 500 nm may be used for this purpose.

As the semiconductor material, a semiconductor having a band gap of 2.4 eV or more is employed.

For example, a semiconductor material of a laser medium, such as diamond, gallium oxide, aluminum nitride, or GaN, having a band gap of 2.4 to 6.2 eV may be used.

It should be noted that the laser light tends to have high transmission efficiency at a longer wavelength while the laser light tends to have high photoelectric conversion efficiency at a shorter wavelength. Thus, in the case of long-distance transmission, a semiconductor material of a laser medium having a laser wavelength (fundamental) of more than 500 nm may be used. In the case that the photoelectric conversion efficiency is prioritized, a semiconductor material of a laser medium having a laser wavelength (fundamental) of less than 200 nm may be used.

These semiconductor materials may be employed in any one of the power sourcing semiconductor laser 111 and the photoelectric conversion element 311. The photoelectric conversion efficiency on the power sourcing side or the powered side is enhanced and the optical power sourcing efficiency is enhanced.

### Second Embodiment

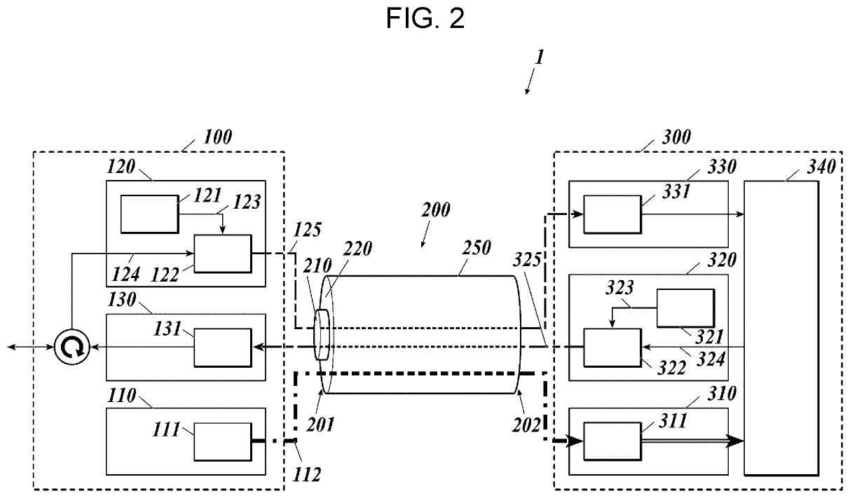

As illustrated in FIG. 2, a power-over-fiber (PoF) system 1 according to the present embodiment includes a power sourcing system and an optical communication system via an optical fiber. The power-over-fiber system 1 includes a first data communication device 100 including power sourcing equipment (PSE) 110, an optical fiber cable 200, and a second data communication device 300 including a powered device (PD) 310.

The power sourcing equipment 110 includes a power sourcing semiconductor laser 111. In addition to the power sourcing equipment 110, the first data communication device 100 includes a transmitter 120 for data communication and a receiver 130. The first data communication device 100 corresponds to, for example, data terminal equipment (DTE) or a relay (repeater). The transmitter 120 includes a signal semiconductor laser 121 and a modulator 122. The receiver 130 includes a signal photodiode 131.

The optical fiber cable 200 includes an optical fiber 250 with a core 210 forming a transmission path for signal light and a cladding 220 disposed around the outer circumference of the core 210 and forming a transmission path for power source light.

The powered device 310 includes a photoelectric conversion element 311. The second data communication device 300 includes, in addition to the powered device 310, a transmitter 320, a receiver 330, and a data processing unit 340. The second data communication device 300 corresponds to, for example, a power end station. The transmitter 320 includes a signal semiconductor laser 321 and a modulator 322. The receiver 330 includes a signal photodiode 331. The data processing unit 340 is a unit for processing a received signal. The second data communication device 300 is a node in a communication network.

Alternatively, the second data communication device 300 may be a node in communication with another node.

The first data communication device 100 is connected to an electric power source so that, for example, the power sourcing semiconductor laser 111, the signal semiconductor laser 121, the modulator 122, and the signal photodiode 131 are electrically driven. The first data communication device 100 is a node in a communication network. Alternatively, the first data communication device 100 may be a node in communication with another node.

The power sourcing semiconductor laser 111 is brought into laser oscillation by electric power from the electric power source and outputs power source light 112.

The photoelectric conversion element 311 converts the power source light 112 transmitted through the optical fiber cable 200 into electric power. The electric power, which has been converted by the photoelectric conversion element 311, serves as driving electric power required for the transmitter 320, the receiver 330, and the data processing unit 340 and, in addition, as driving electric power required for others within the second data communication device 300. Furthermore, the second data communication device 300 may be capable of outputting the electric power, which has been converted by the photoelectric conversion element 311, to an external device.

Meanwhile, the modulator 122 of the transmitter 120 modulates laser light 123 from the signal semiconductor laser 121 in accordance with transmission data 124 and outputs the modulated light as signal light 125.

The signal photodiode 331 of the receiver 330 demodulates the signal light 125 transmitted through the optical fiber cable 200 into an electric signal and outputs the electric signal to the data processing unit 340. The data processing unit 340 transmits data of the electric signal to a node while receiving data from the node and outputs the received data as transmission data 324 to the modulator 322.

The modulator 322 of the transmitter 320 modulates laser light 323 from the signal semiconductor laser 321 in accordance with the transmission data 324 and outputs the modulated light as signal light 325.

The signal photodiode 131 of the receiver 130 demodulates the signal light 325, which has been transmitted through the optical fiber cable 200, into an electric signal for output. The data of the electric signal is transmitted to a node while data from the node is the transmission data 124.

The power source light 112 and the signal light 125 from the first data communication device 100 are input to one end 201 of the optical fiber cable 200. The power source light 112 propagates in the cladding 220 whereas the signal light 125 propagates in the core 210. The power source light 112 and the signal light 125 are output from another end 202 of the optical fiber cable 200 to the second data communication device 300.

The signal light 325 from the second data communication device 300 is input to the other end 202 of the optical fiber cable 200, propagates in the core 210, and is output from the one end 201 to the first data communication device 100.

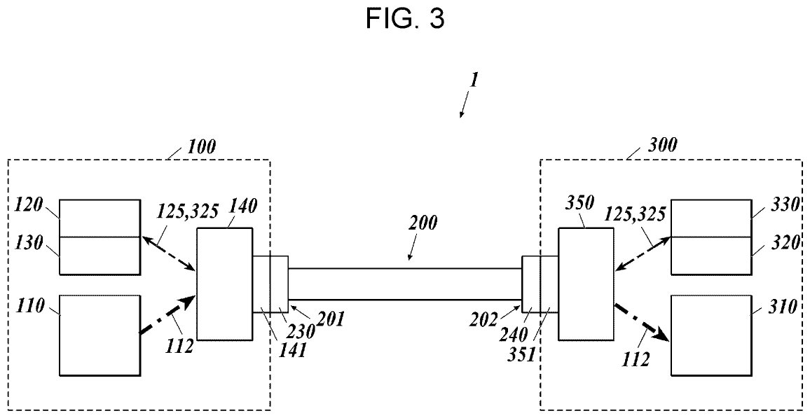

The first data communication device 100 is provided with an optical input/output unit 140 and an optical connector 141 fixed thereto, as illustrated in FIG. 3. The second data communication device 300 is provided with an optical input/output unit 350 and an optical connector 351 fixed thereto. An optical connector 230 disposed at the one end 201 of the optical fiber cable 200 is connected to the optical connector 141. An optical connector 240 disposed at the other end 202 of the optical fiber cable 200 is connected to the optical connector 351. The optical input/output unit 140 guides the power source light 112 into the cladding 220, guides the signal light 125 into the core 210, and guides the signal light 325 into the receiver 130. The optical input/output unit 350 guides the power source light 112 into the powered device 310, guides the signal light 125 into the receiver 330, and guides the signal light 325 into the core 210.

As described above, the one end 201 of the optical fiber cable 200 can be connected to the first data communication device 100 and the other end 202 of the optical fiber cable 200 can be connected to the second data communication device 300, and the optical fiber cable 200 transmits the power source light 112. Furthermore, the optical fiber cable 200 bi-directionally transmits the signal light 125, 325 in the present embodiment.

The same semiconductor material as that of the first embodiment is employed to constitute the semiconductor region for achieving an optic/electric conversion effect between the power sourcing semiconductor laser 111 and the photoelectric conversion element 311. A high optical power sourcing efficiency is thereby achieved.

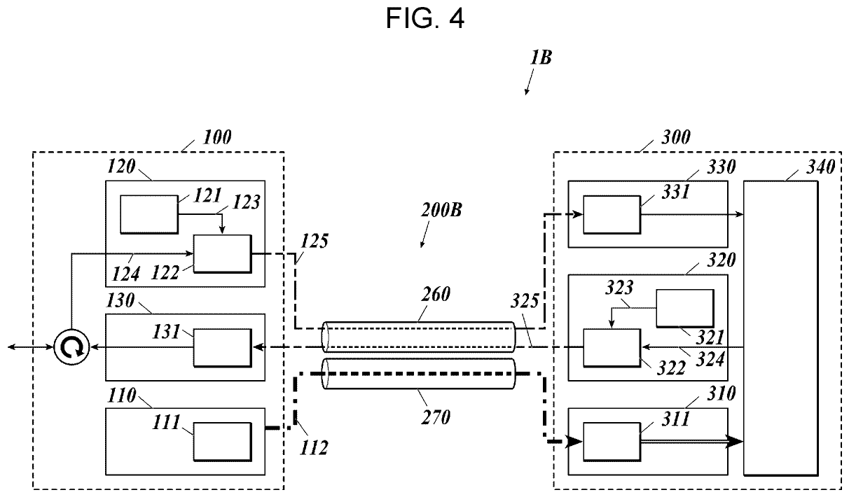

As in an optical fiber cable 200B of a power-over-fiber system 1B illustrated in FIG. 4, an optical fiber 260 for transmitting the signal light and an optical fiber 270 for transmitting the power source light may be separately provided. Multiple optical fiber cables 200B may be provided.

### (2) Employment of Unit for Returning Portion of Power Source Light

A power-over-fiber system employing a unit for returning a portion of the power source light will be described.

### Third Embodiment

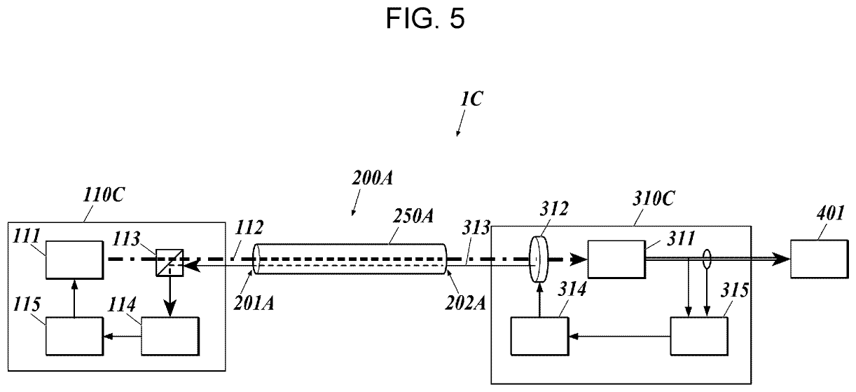

FIG. 5 is a configuration diagram illustrating a power-over-fiber system employing a unit for returning a portion of power source light according to a third embodiment. In FIG. 5, the same components as those described above are denoted by the same reference signs and detailed description thereof is omitted.

A power-over-fiber system 1C according to the third embodiment includes power sourcing equipment 110C, a powered device 310C, and an optical fiber 250A. The powered device 310C is connected to a load 401 consuming electric power supplied from power source light 112.

The powered device 310C includes a photoelectric conversion element 311 for converting the power source light 112 into electric power, a light returner 312 for returning a portion of the input power source light 112, as return light 313, to an exterior (optical fiber 250A) of the device, a return controller 314 for controlling the light returner 312 to vary the magnitude of the return light 313, and an electric power monitor 315 for monitoring surplus electric power.

The light returner 312 is a dimmable mirror that, for example, allows a portion of the received light to pass through while reflecting another portion of the received light. The dimmable mirror may be configured to vary a reflection quantity by electrically varying optical characteristics or may be configured to vary the reflection quantity by varying the edge of the mirror within a laser spot through an actuator. In addition, the light returner 312 may adopt various techniques and may have a configuration in which, for example, one of the lasers split using a beam splitter with a variable splitting ratio is returned to the optical fiber 250A.

The electric power monitor 315 monitors surplus electric power at the load 401. The load 401 may be configured to be connected to an exterior of the powered device 310C and to also include a component consuming the electric power in the powered device 310C. The surplus electric power corresponds to the electric power determined by subtracting the electric power consumed by the load 401 from the electric power acquired from the photoelectric conversion element 311. The electric power monitor 315 detects, for example, a current and a voltage output to the load 401 and calculates the surplus electric power. Since the input to the load 401 includes, for example, a capacitive component, the input voltage increases when the supplied electric power is higher than the consumed electric power whereas the input voltage decreases when the supplied electric power is lower than the consumed electric power. The electric power monitor 315 can calculate the surplus electric power from the input voltage at the load 401 and the electric power supplied to the load 401. Furthermore, the electric power monitor 315 may detect the temperature of the photoelectric conversion element 311 and add the detected temperature to parameters for calculation of the surplus electric power. Since the magnitude of the surplus electric power varies heat loss of the photoelectric conversion element 311, taking a variation in temperature of the photoelectric conversion element 311 into consideration can enhance accuracy in calculation of the surplus electric power. In addition, the electric power monitor 315 may detect the intensity of light split from the power source light 112 at a small fixed ratio and calculate the power of the power source light 112 and the supplied electric power from the detected intensity, and subtract the consumed electric power from the supplied electric power that has been calculated to thereby calculate the surplus electric power. In addition, various techniques may be employed to determine the surplus electric power.

The return controller 314 controls the light returner 312 in accordance with the magnitude of the surplus electric power, which is the result of monitoring by the electric power monitor 315, such that the intensity of the return light 313 varies. The return controller 314 may control the light returner 312 such that the intensity of the return light 313 and the magnitude of the surplus electric power have a predetermined relation, such as proportion.

Alternatively, the return controller 314 controls the light returner 312 such that the ratio of the return light 313 to the power source light 112 and the magnitude of the surplus electric power have a predetermined relation, such as proportion. In addition, the return controller 314 may be configured to control the light returner 312 such that the surplus electric power within a target range, the surplus electric power in a range smaller than the target range, and the surplus electric power in a range larger than the target range can be distinguished by the return light 313.

The power sourcing equipment 110C includes a power sourcing semiconductor laser 111, a splitter 113 for splitting forward laser light and backward laser light, a light receiving element 114 for detecting the split return light 313, and a power controller 115 for controlling output power of the power sourcing semiconductor laser 111 in accordance with a detected value of the return light 313.

The splitter 113 can adopt a configuration having a Faraday element used in, for example, an optical isolator. The splitter 113 splits and transmits the return light 313 to the light receiving element 114.

The light receiving element 114 is a semiconductor light receiving element, for example, a photodiode, and outputs, to the power controller 115, a signal according to the intensity of the return light 313.

The power controller 115 controls the power of the power source light 112 transmitted to the powered device 310C such that the return light 313 is at a predetermined value. For the predetermined value of the return light 313, a positive target value can be adopted where the surplus electric power in the powered device 310C is not excessive. The predetermined value of the return light 313 may be determined according to the relation between the return light 313 and the surplus electric power. For example, when the magnitude of the return light 313 represents the magnitude of the surplus electric power, the predetermined value of the return light 313 corresponds to the magnitude of the return light 313 indicating a target value of the surplus electric power. When the ratio of the return light 313 to the power source light 112 represents the magnitude of the surplus electric power, the predetermined value of the return light 313 corresponds to the ratio of the return light 313 indicating a target value of the surplus electric power.

The power controller 115 controls the power of the power source light 112 by controlling the magnitude of driving electric power input to the power sourcing semiconductor laser 111. Alternatively, the power controller 115 may control the power of the power source light 112 transmitted to the powered device 310C by controlling the splitting ratio of the beam splitter for splitting the power source light 112. In the case that the power source light 112 is split and supplied from a single power sourcing equipment 110C unit to multiple powered devices 310C, the magnitude of the power source light 112 supplied to a single powered device 310C can be varied by varying the splitting ratio.

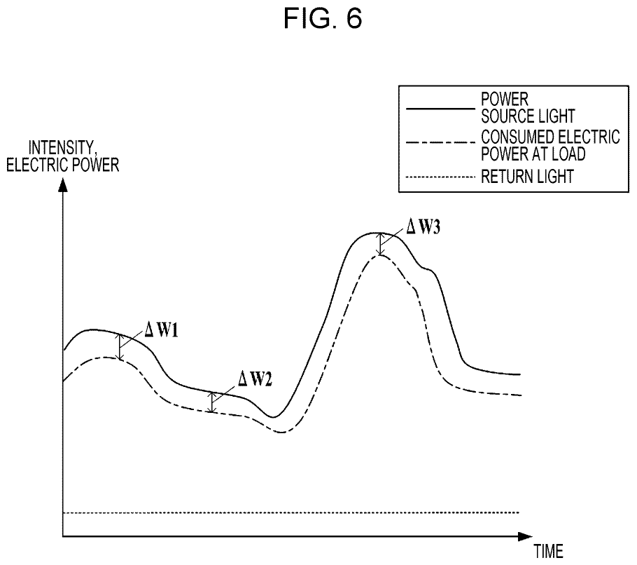

FIG. 6 is a timing chart illustrating an example of operation of the power-over-fiber system according to the third embodiment. FIG. 6 illustrates an example where the magnitude of the return light 313 is varied in the powered device 310C according to the magnitude of the surplus electric power and the power is controlled in the power sourcing equipment 110C such that the magnitude of the return light 313 is restored to a predetermined value.

According to such control, the return light 313 returned from the powered device 310C to the power sourcing equipment 110C increases upon a decrease in the consumed electric power at the load 401 and a slight increase in the surplus electric power in the powered device 310C. In response to a variation in magnitude of the return light 313, the power controller 115 of the power sourcing equipment 110C reduces the power of the power source light 112 such that the return light 313 is restored to the original magnitude.

Meanwhile, upon an increase in the consumed electric power at the load 401 and a slight decrease in the surplus electric power in the powered device 310C, the magnitude of the return light 313 returned from the powered device 310C to the power sourcing equipment 110C decreases. In response to a variation in magnitude of the return light 313, the power controller 115 raises the power of the power source light 112 such that the return light 313 is at the original magnitude.

As illustrated in the timing chart of FIG. 6, the control of returning the return light 313 and the control of the power of the power source light 112 as described above vary the power of the power source light 112 such that the intensity of the return light 313 is kept constant, even if the consumed electric power at the load 401 varies greatly. Accordingly, the surplus electric power at ΔW1 to ΔW3 is kept substantially constant with a variation in power of the power source light 112.

As described above, in the power-over-fiber system 1C according to the third embodiment, the power source light 112 is supplied from the power sourcing equipment 110C to the powered device 310C through the optical fiber 250A. In addition, the return light 313 representing the magnitude of surplus electric power is returned from the powered device 310C to the power sourcing equipment 110C through the optical fiber 250A. Thus, the power source light 112 can also be used to transmit information on the surplus electric power from the powered device 310C to the power sourcing equipment 110C. Furthermore, the transmission path for the power source light 112 can also be used to transmit the information on the surplus electric power from the powered device 310C to the power sourcing equipment 110C due to the configuration in which the power source light 112 and the return light 313 are transmitted through a common transmission path in the single optical fiber 250A. The power sourcing equipment 110C controls the intensity of the power source light 112 in accordance with the information on the surplus electric power. Thereby, power that follows the consumed electric power on the powered side can be supplied.

Furthermore, in the power-over-fiber system 1C according to the third embodiment, the return light 313 can be returned in a compact configuration and at low loss because the light returner 312 includes a dimmable mirror, and the power-over-fiber system 1C is thus suitable for a system transmitting electric power via the power source light 112.

Furthermore, in the power-over-fiber system 1C according to the third embodiment, the return controller 314 varies the magnitude of the return light 313 according to the magnitude of the surplus electric power. Thus, the control process of the return controller 314 can be simplified and, for example, control independent of software processing can be readily achieved. Thus, the return light 313 can be controlled in this case even if higher layers than the physical layer are not in operation, for example, at start of power sourcing.

Furthermore, in the power-over-fiber system 1C according to the third embodiment, the power controller 115 of the power sourcing equipment 110C controls the power of the power source light 112 such that the return light 313 is restored to a predetermined value representing non-excessive positive surplus electric power. Thus, electric power shortage in the powered device 310C can be reduced or prevented and the return light 313 can be generated from the surplus electric power.

It should be noted that, although the third embodiment illustrates an example in which the power source light 112 and the return light 313 are transmitted through a common transmission path, the power source light 112 and the return light 313 may be transmitted through different optical fibers or different transmission paths (for example, the core and the first cladding) of a common optical fiber. Although the third embodiment illustrates the configuration where the return light 313 has a magnitude that represents the magnitude of the surplus electric power, a configuration may be employed where modulation of the return light 313 represents the magnitude of the surplus electric power.

The control of the power of the power source light 112 in accordance with the return light 313 as described in the third embodiment may be employed in the system configuration in FIG. 2 or 4. Specifically, the power sourcing equipment 110 in FIG. 2 or 4 is replaced with the power sourcing equipment 110C according to the third embodiment, and the powered device 310 in FIG. 2 or 4 is replaced with the powered device 310C according to the third embodiment. In addition, the cladding 220 of the optical fiber 250 in FIG. 2 or the optical fiber 270 in FIG. 4 may be adopted as the transmission path for the power source light 112 and the return light 313.

### Fourth Embodiment

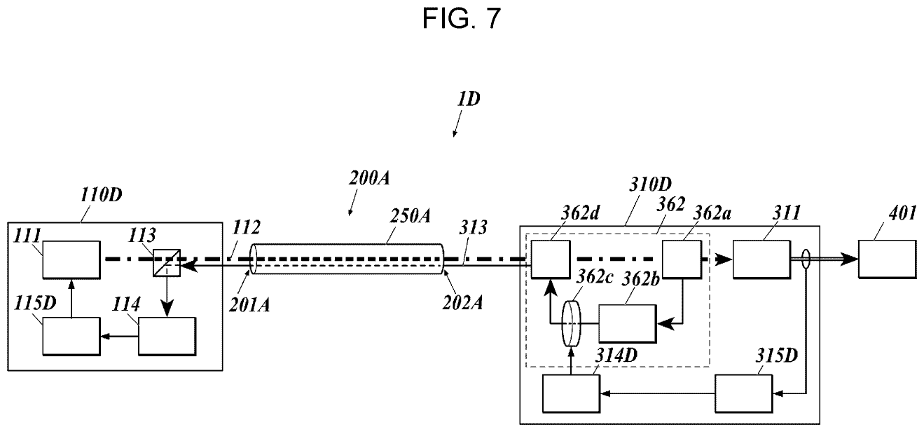

FIG. 7 is a configuration diagram illustrating a power-over-fiber system according to a fourth embodiment employing a unit for returning a portion of power source light. In FIG. 7, the same components as those described above are denoted by the same reference signs and detailed description thereof is omitted.

A power-over-fiber system 1D according to the fourth embodiment includes power sourcing equipment 110D, a powered device 310D, and an optical fiber 250A. The powered device 310D is connected to a load 401 consuming electric power.

The powered device 310D includes a photoelectric conversion element 311 for converting power source light 112 into electric power, a light returner 362 for returning, as return light 313, a portion of the input power source light 112 to an exterior (optical fiber 250A) of the device, a return controller 314D for controlling the light returner 362, and an electric power monitor 315D for monitoring a relation between supply and demand of the electric power at the load 401.

The light returner 362 is configured to return, as the return light 313, a portion of the power source light 112 to an optical path for the power source light 112 and to be able to vary the intensity of the return light 313 through electric control. The light returner 362 may include a wavelength converter 362b for shifting the wavelength of the return light 313 from the wavelength of the power source light 112.

More specifically, the light returner 362 includes an optical splitter 362a that splits a portion of the power source light 112, the wavelength converter 362b for shifting the wavelength of the split power source light 112, a dimmable mirror 362c capable of electrically controlling a transmission quantity, and an optical coupler 362d for returning, as the return light, the light transmitted through the dimmable mirror 362c to the optical path for the power source light 112. Control of the dimmable mirror 362c can vary the intensity of the return light 313 returned from the light returner 362. The intensity of the return light 313 may be varied by employing various configurations, such as the dimmable mirror 362c that varies the quantity of the transmitted light through a variation in optical characteristics, a mechanical dimmable mirror that varies the position of its edge within a beam spot through an actuator to vary the quantity of the transmitted light, or an optical splitter that has a variable splitting ratio. The wavelength converter 362b can include various types of wavelength converting element.

The electric power monitor 315D compares a quantity of the electric power supplied to the load 401 (time integration of received electric power at the load 401) with a quantity of the electric power consumed by the load 401, calculates a difference between supply and demand from these quantities, and outputs a result of calculation to the return controller 314D. The quantity of the consumed electric power at the load 401 may be calculated by detecting a current input to the load 401 or may be calculated from the consumed electric power according to an operation mode by receiving an operation mode signal from the load 401. The quantity of the electric power supplied to the load 401 may be estimated by detection of the current input to the load 401 in accordance with switching of the electric power of the power source light 112 in two or more steps or may be estimated by receiving, from the return controller 314D, a signal value indicating the requested power of the power source light 112.

The return controller 314D controls the light returner 362 such that the return light 313 represents the value of a binary or multivalued signal. The signal value of the return light 313 represents the requested power of the power source light 112. The power of the power source light 112 is switched in multiple steps in accordance with the signal value of the return light 313. The return controller 314D switches the signal value of the return light 313 such that the difference, calculated by the electric power monitor 315D, between supply and demand of the electric power at the load 401 shifts within a predetermined range.

The power sourcing equipment 110D includes a power sourcing semiconductor laser 111, a splitter 113 for splitting forward laser light and backward laser light, a light receiving element 114 for detecting the split return light 313, and a power controller 115D for controlling output power of the power sourcing semiconductor laser 111 stepwise in accordance with a detected value of the return light 313.

The splitter 113 can adopt a configuration with a Faraday element used in, for example, an optical isolator. The splitter 113 splits and transmits the return light 313 to the light receiving element 114.

The light receiving element 114 is a semiconductor light receiving element, for example, a photodiode or the like, and outputs a signal to the power controller 115D according to the intensity of the return light 313.

The splitter 113 or the light receiving element 114 may have such wavelength characteristics as to remove reflected light of the power source light 112 and have a predetermined effect on the return light 313 with a wavelength shifted through the wavelength converter 362b. Alternatively, an optical filter for removing the wavelength of the power source light 112 may be disposed between, for example, the splitter 113 and the light receiving element 114.

The power controller 115D controls the power of the power source light 112 stepwise in accordance with a signal value indicated by the return light 313. The power of the power source light 112 may be controlled in multiple steps, for example, two steps of high and low, three steps, or four steps. The number of steps of the power may be the same as the number of signal values of the return light 313. The power controller 115D can control the power of the power source light 112 by controlling the magnitude of driving electric power of the power sourcing semiconductor laser 111.

### <Explanation of Operation>

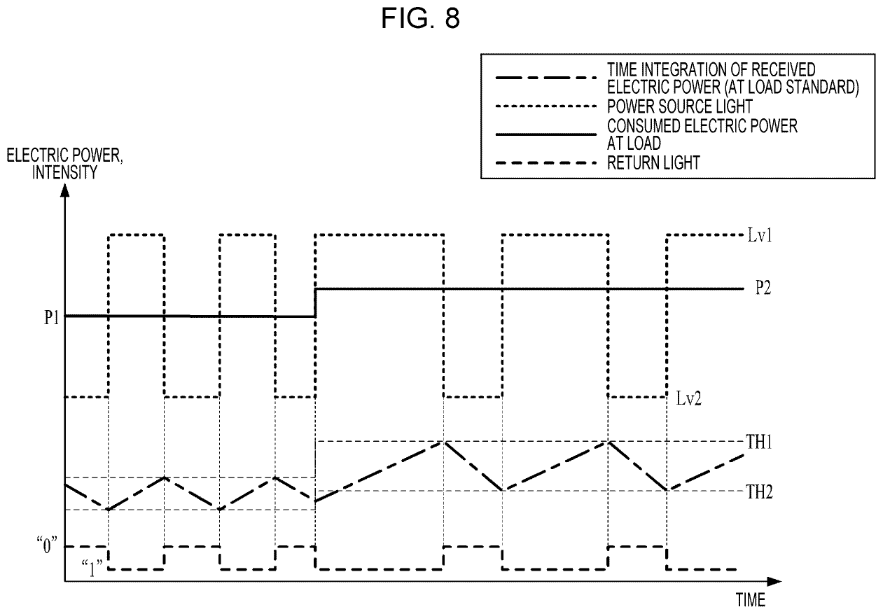

FIG. 8 is a timing chart for explaining an example of operation of the power-over-fiber system 1D according to the fourth embodiment. A configuration will be described where the power sourcing equipment 110D can switch the power of the power source light 112 between a first level Lv1 and a second level Lv2 and the return light 313 represents a binary signal with a high level (signal value of “0”) and a low level (signal value of “1”). The consumed electric power at the load 401 is switched in two steps of consumed electric power P1 in a first operation mode and consumed electric power P2 in a second operation mode.

Under such conditions, the power of the power source light 112 at the first level Lv1 is preset such that the received electric power corresponding to the power source light 112 at the first level Lv1 is at or above maximum consumed electric power P1 at the load 401. In addition, the power of the power source light 112 at the second level Lv2 is preset such that the received electric power corresponding to the power source light 112 at the second level Lv2 is at or below minimum consumed electric power P2 at the load 401 during operation thereof. The corresponding received electric power in this context refers to electric power convertible by the photoelectric conversion element 311 and corresponds to a value determined by multiplying the power of the power source light 112 by conversion efficiency of the photoelectric conversion element 311.

In the powered device 310D, the electric power monitor 315D always calculates, as a relation of supply and demand of the electric power, time integration of the received electric power at a load standard, in other words, the time integration of the electric power determined by subtracting the consumed electric power at the load 401 from the received electric power. The received electric power may be determined from the signal value of a power request from the return controller 314D, and the consumed electric power at the load 401 may be determined according to an operation mode of the load 401. As illustrated in FIG. 8, the time integration of the received electric power calculated by the electric power monitor 315D increases with a certain gradient when the power of the power source light 112 is at the first level Lv1. The time integration of the received electric power calculated by the electric power monitor 315D decreases with a certain gradient when the power of the power source light 112 is at the second level Lv2. The gradient is determined according to a difference between the consumed electric power and the received electric power at the load 401.

The electric power monitor 315D may estimate the time integration of the received electric power at the load standard from the input voltage at the load 401 because the time integration of the received electric power is approximately equal to a value of the voltage at the input capacitance of the load 401.

The return controller 314D performs a process comparing the time integration, calculated by the electric power monitor 315D, of the received electric power (at the load standard) with thresholds (an upper threshold TH1 and a lower threshold TH2) having a hysteresis width therebetween. The hysteresis width is appropriately determined so as not to exceed the ability of the load 401 to buffer the electric power. The upper threshold TH1 and the lower threshold TH2 may be set to different values dependent on the operation modes of the load 401 as illustrated in FIG. 8 or may be set to values independent of the operation modes of the load 401.

The return controller 314D controls the light returner 362 according to the result of comparison to switch between the return light 313 with the signal value of “1” and the return light 313 with the signal value of “0”. The signal values “0” and “1” are identified by the intensity of the return light 313.

In the power sourcing equipment 110D receiving the return light 313, the power controller 115D monitors the signal value of the return light 313 and switches the power of the power source light 112 between the first level Lv1 and the second level Lv2 according to the signal value.

Such operation allows the time integration of the received electric power to follow the quantity of the consumed electric power at the load 401 within a predetermined hysteresis width and achieves supply of the electric power with less surplus relative to the consumed electric power at the load 401.

As described above, in the power-over-fiber system 1D according to the fourth embodiment, the powered device 310D receives the power source light 112 to supply the load 401 with electric power and returns, as the return light 313, a portion of the power source light 112 to the power sourcing equipment 110D. Furthermore, the return controller 314D controls the light returner 362 according to the relation between supply and demand of the electric power at the load 401 and returns the return light 313 representing the value of a binary or multivalued signal to the power sourcing equipment 110D. Furthermore, the power sourcing equipment 110D switches the power of the power source light 112 stepwise in response to the signal value of the return light 313. Such a configuration can control the power of the power source light 112 and reduce or prevent generation of surplus of electric power supplied from the power sourcing equipment 110D to the powered device 310D even if the consumed electric power at the load 401 varies. Furthermore, the powered device 310D returns the return light 313 representing the value of a binary or multivalued signal. The power sourcing equipment 110D switches the power source light 112 in two or more steps in response to the signal value. Such digital procedures can simplify processes for control and comparison and achieve reduced costs of components for control and comparison.

Furthermore, in the power-over-fiber system 1D according to the fourth embodiment, the light returner 362 of the powered device 310D includes the wavelength converter 362b to shift the wavelength of the return light 313 from the wavelength of the power source light 112. Thus, the power sourcing equipment 110D can readily distinguish the reflected light of the power source light 112 from the return light 313. The powered device 310D can reduce the optical quantity of the power source light 112 used for generation of the return light 313. Thus, power sourcing efficiency can be enhanced. Reflected light due to, for example, breakage of the optical fiber 250A can also be addressed.

Furthermore, in the power-over-fiber system 1D according to the fourth embodiment, the electric power monitor 315D calculates the time integration of the received electric power at a load standard (the difference between the quantity of the electric power supplied to the load 401 and the quantity of the consumed electric power at the load 401). Furthermore, the return controller 314D of the powered device 310D determines the signal value of the return light 313 in accordance with the time integration of the received electric power at the load standard. Thus, surplus electric power supplied to the load 401 can be reduced with high reliability even if a relatively large hysteresis width is taken and repetitions of switching of the power of the power source light 112 are reduced. Since the repetitions of switching of the power of the power source light 112 can be reduced, degradation of the element due to switching of the power can be suppressed.

The fourth embodiment illustrates an example in which the power source light 112 and the return light 313 are transmitted through a common transmission path. However, the power source light 112 and the return light 313 may be transmitted through different optical fibers or different transmission paths (for example, the core and the first cladding) of a common optical fiber. Although the operation example in FIG. 8 illustrates the configuration where the consumed electric power at the load 401 is switched in two steps, the consumed electric power at the load 401 may be continuously varied. In this case, the electric power monitor 315D can calculate the quantity of the consumed electric power from the input current and the input voltage at the load 401. Although the operation example in FIG. 8 illustrates the configuration where the signal value of the return light 313 is binary and the power of the power source light 112 is switched in two steps, the signal value may be multivalued, for example, three-valued or four-valued, and the power may be switched in multiple steps, for example, three steps or four steps. For example, suppose a situation where the consumed electric power at the load 401 exceeds the received electric power at the first level Lv1, in addition to the operation in FIG. 8. In such a case, a configuration may be adopted where the power of the power source light 112 is set to a zeroth level Lv0 higher than the first level Lv1 and the same control as that in the FIG. 8 is performed when the consumed electric power at the load 401 is at or below the received electric power corresponding to the first level Lv1. In addition, a configuration may be adopted where the power source light 112 at the zeroth level Lv0 is requested when the consumed electric power at the load 401 exceeds the received electric power at the first level Lv1. Specifically, a configuration may be adopted that uses a value of a three-valued signal of the return light 313 to request the power source light 112 at the zeroth level Lv0 under the conditions that the consumed electric power at the load 401 exceeds the received electric power at the first level Lv1 and that the time integration of the received electric power reaches the threshold TH2. Such a configuration achieves multivalued control.

The control of the power of the power source light 112 in accordance with the return light 313 as illustrated in the fourth embodiment may be employed in the system configuration in FIG. 2 or 4. Specifically, the power sourcing equipment 110 in FIG. 2 or 4 is replaced with the power sourcing equipment 110D in the fourth embodiment and the powered device 310 in FIG. 2 or 4 is replaced with the powered device 310D in the fourth embodiment. In addition, the cladding 220 of the optical fiber 250 in FIG. 2 or the optical fiber 270 in FIG. 4 may be adopted as a transmission path for the power source light 112 and the return light 313.

The embodiments of the present disclosure have been described above. The embodiments are illustrated as examples and can be embodied in various other forms. Omission, replacement, or variation of the component(s) can be made without departing from the spirit of the invention. For example, the load supplied with the electric power from the powered device is not limited to a communication device or wireless device and may be any device. The configuration of a detector for detecting the magnitude of the electric power is not limited to the specific examples illustrated in the embodiments and various circuit configurations may be adopted.

### INDUSTRIAL APPLICABILITY

The present disclosure can be used in powered devices, power sourcing equipment, and power-over-fiber systems.

1. A powered device comprising:
a photoelectric conversion element configured to convert power source light input from an exterior of the device into electric power;
an electric power monitor configured to monitor surplus electric power;
a light returner configured to output, as return light, a portion of the power source light to the exterior of the device; and
a return controller configured to control the light returner in accordance with a result of monitoring by the electric power monitor.

2. The powered device according to claim 1, wherein
the light returner is a dimmable mirror for reflecting a portion of the power source light.

3. The powered device according to claim 1, wherein
the return controller varies a magnitude of the return light according to a magnitude of the surplus electric power.

4. Power sourcing equipment comprising:
a laser oscillator configured to convert electric power into power source light for output to an exterior of the equipment;
a light receiving element configured to receive return light returned from the exterior of the equipment; and
a power controller configured to control power of the power source light in accordance with the return light.

5. The power sourcing equipment according to claim 4, wherein
the power controller controls the power of the power source light such that the return light is restored to a predetermined value representing positive surplus electric power.

6. A power-over-fiber system comprising:
the powered device according to claim 1;
power sourcing equipment comprising:
a laser oscillator configured to convert electric power into power source light for output to an exterior of the equipment;
a light receiving element configured to receive return light returned from the exterior of the equipment; and
a power controller configured to control power of the power source light in accordance with the return light;
an optical fiber for transmitting the power source light; and
an optical fiber for transmitting the return light.

7. The power-over-fiber system according to claim 6, wherein
the power source light and the return light are transmitted through a same transmission path in one optical fiber.

8. A powered device comprising:
a photoelectric conversion element configured to convert power source light input from an exterior of the device into electric power;
a light returner capable of outputting, as return light, a portion of the power source light to the exterior of the device;
an electric power monitor configured to monitor a relation between supply and demand of electric power at a load; and
a return controller configured to control the light returner,
wherein the return controller causes the return light to be output from the light returner in accordance with a result of monitoring by the electric power monitor, the return light representing a value of a binary or multivalued signal.

9. The powered device according to claim 8, wherein
the light returner comprises a wavelength converter for converting a wavelength of a portion of the power source light, and
the return light has a wavelength different from the power source light.

10. The powered device according to claim 8, wherein
the return controller determines the value of the signal of the return light in accordance with a difference between a quantity of electric power supplied from the photoelectric conversion element and a quantity of electric power consumed by the load.

11. Power sourcing equipment comprising:
a laser oscillator configured to convert electric power into power source light for output to an exterior of the equipment;
a light receiving element configured to receive return light returned from the exterior of the equipment; and
a power controller configured to switch power of the power source light stepwise in accordance with the return light.

12. The power sourcing equipment according to claim 11, wherein
the power controller switches the power of the power source light in two or more steps according to a value of a binary or multivalued signal represented by the return light.

13. A power-over-fiber system comprising:
the powered device according to claim 8;
power sourcing equipment comprising:
a laser oscillator configured to convert electric power into power source light for output to an exterior of the equipment;
a light receiving element configured to receive return light returned from the exterior of the equipment; and
a power controller configured to switch power of the power source light stepwise in accordance with the return light;
an optical fiber for transmitting the power source light; and
an optical fiber for transmitting the return light.

14. The power-over-fiber system according to claim 13, wherein
the power source light and the return light are transmitted through a same transmission path in one optical fiber.
